(19) United States
(12) Patent Application Publication
(10) Pub. No.: US 2026/0058600 A1
(43) Pub. Date: Feb. 26, 2026

(54) BALANCED DEPLOYABLE SOLAR PHOTOVOLTAIC ARRAY SYSTEM

(71) Applicant: Lux Infinitum LLC, Atlanta, GA (US)

(72) Inventor: Tristan Al-Haddad, Atlanta, GA (US)

(21) Appl. No.: 19/298,903

(22) Filed: Aug. 13, 2025

Related U.S. Application Data
(60) Provisional application No. 63/687,014, filed on Aug. 26, 2024.

(51) Int. Cl. H02S 30/20; H02S 20/23

(52) U.S. Cl. CPC H02S 30/20; H02S 20/23

(57) ABSTRACT

A balanced deployable solar photovoltaic array system includes a base supporting a foldable solar panel array. The base has a hexahedron shape (a cube shape or rectangular cuboid shape) and includes an upper frame and a lower frame, each having quadrilateral shapes either square or rectangular. The upper frame is connected to the lower frame and supported by vertical corner posts. The foldable solar panel array includes a four-point expandable scissor structure with support sections. Each support section supports a solar photovoltaic panel or panels. A center support section is connected to the upper frame. The foldable solar panel array is deployed by moving the lowermost support section downwardly, rearwardly, and then upwardly that at the same time the support sections move upwardly, forwardly, and then downwardly. Stowing is accomplished by reversing the order of movement.

### FIELD OF THE INVENTION

This invention relates to a solar photovoltaic array system and more particularly to a balanced deployable solar photovoltaic array system (hereinafter “balanced solar array system”).

### BACKGROUND OF THE INVENTION

One of the most significant barriers to implementing photovoltaic power generation plants in the United States is not in the fundamental development of the solar photovoltaic panels, but rather in the solar array system designs. The Department of Energy recognized this issue by launching the Sunshot Initiative in 2010 which focused on solar array system designs rather than photovoltaic panel fundamentals or manufacturing hurdles. Current reports from the National Renewable Energy Laboratory state that solar array system costs are approaching 70% of total systems costs. Installation of solar photovoltaic power generator systems for a period of 5 to 10 years on a particular site is not currently cost effective because of the costs involved in planning, designing, permitting, and installing of solar power generation exceed that of other power generation systems.

No current practical solar array system exists that will allow short-term code compliant installation of solar photovoltaic power generator systems in a cost-effective manner. PWRstation SA of Lausanne, Switzerland markets a mobile rack solar panel system under the mark EXOrac. The EXOrac system is only able to be installed for very short periods due to an inability to resist wind loads generally required in the permitting process for solar photovoltaic generator systems. The EXOrac system requires continuous monitoring by humans and is manually retracted and rolled indoors to be stored during a wind event.

### SUMMARY OF THE INVENTION

The balanced solar array system of the present invention overcomes the problems identified above.

Overview The balanced solar array system of the present invention is a fully integrated factory fabricated photovoltaic array system capable of deploying to create a long span photovoltaic array that is up to seven times larger than its stowed transportation footprint. This allows the balanced solar array system of the present invention to be built in a factory, delivered to a site, deployed using human power, and create electricity within minutes. Conversely, the balanced solar array system can stow into a compressed format both for transportation to a new site or to ruggedize to survive extreme weather events such as hurricanes, tornados, and snowstorms. The balanced solar array system is very well suited for conventional permanent photovoltaic installations including electric vehicle charge stations, surface parking lot canopy systems, airplane hangars, and residential applications. Additionally, a containerized version of the balanced solar array system is very well suited for disaster relief, forward operating bases for the military, mobile charge stations for construction, and agricultural applications as well as community solar projects.

Decoupled From Land Assets Because the balanced solar array system can be stowed to the size of a small container that can be loaded onto a trailer, the balanced solar array systems can be rapidly relocated from one site to the next with very low cost and low energy. This allows the balanced solar array system to be decoupled from the land, which is transformative to the business model of renewable energy infrastructure.

Kinematic Optimization The balanced solar array system's unique design employs a four-point hinged scissor structure between a base frame and a foldable solar panel array that is configured in such a way that the folded solar panel array is balanced above and below the base frame, thereby defining a “zero-line”. This balanced design allows for the foldable solar panel array to be gravity actuated whereas the downward force acting on the components below the zero line creates the necessary force to lift the symmetrical components above the zero-line. This balanced configuration allows for the foldable solar panel array to be deployed by a single person in both the deployed and stowed directions.

Topological Transformation Once deployed, a support-tie component is engaged to transform the quadrilateral configuration of the foldable solar panel array into a triangulated configuration thus transforming the foldable solar panel array from a non-stable 171 deployable configuration into a stable rigid configuration for permanent installs. This transformability allows the balanced solar array system to be flexible when desired (during deployment) and then static when desired (during energy production operations and during transport).

Recoverabilty The balanced solar array system has the ability to stow during extreme weather events (hurricanes for example) and then quickly recover to provide immediate power post storm.

Material Optimization The balanced solar array system's ability to stow during an extreme weather event means that it can be materially optimized and designed to a much lower wind and snow load than a conventional system allowing for up to 50% material reduction in the primary structure as compared to a conventional steel photovoltaic racking system.

The balanced solar array system of the present invention comprises a base that supports a foldable solar panel array. The base is a hexahedron shape (a cube shape or rectangular cuboid shape). The base has an upper frame and a lower frame (each being quadrilateral shapes either square or rectangular). The upper frame is the same size as the lower frame. The upper and lower frames are connected at their four corners by vertical corner posts.

The foldable solar panel array comprises a four-point expandable scissor structure with a number of support sections. Each support section supports a photovoltaic panel or panels. A center support section of the expandable scissor structure, with its center photovoltaic panel, is fixed to the upper frame of the base. A zero line lies in the plane of the upper frame and extends in the direction of the length of the foldable solar panel array when unfolded and deployed.

In order to deploy the stowed foldable solar panel array, the lowermost support section, with its lowermost solar photovoltaic panel or panels, is pulled downwardly and rearwardly in a first direction, which causes the uppermost support sections above the center support section to move upwardly and forwardly in a second direction. Because the center support section of the foldable solar panel array is fixed to the stationary upper frame, the lower support sections of the expandable scissor structure initially move downwardly and rearwardly, and then the lower support sections move upwardly while the upper support sections above the center support section initially move upwardly and forwardly, and then the upper support sections move downwardly until the expandable scissor structure lies essentially parallel to the zero line. In that position, the balanced solar array system is in a fully deployed configuration.

The balanced solar array system is stowed by pulling downwardly, forwardly, and then upwardly on the lowermost support section which in turn causes the uppermost support sections above the center support section to move upwardly, rearwardly, and then downwardly to the stowed configuration.

Further objects, features and advantages will become apparent upon consideration of the following detailed description of the invention when taken in conjunction with the drawings and the appended claims.

### BRIEF DESCRIPTION OF THE DRAWINGS

FIG. 1 is a side elevation view of a balanced deployable solar photovoltaic array system in a deployed configuration in accordance with the present invention.

FIGS. 2A-2D are a top plan view, a front perspective view, a side elevation view, and a front elevation view of the balanced deployable solar photovoltaic array system in a stowed configuration in accordance with the present invention.

FIGS. 3A-3D are a top plan view, a front perspective view, a side elevation view, and a front elevation view of the balanced deployable solar photovoltaic array system in a first intermediate configuration between stowed and deployed in accordance with the present invention.

FIGS. 4A-4D are a top plan view, a front perspective view, a side elevation view, and a front elevation view of the balanced deployable solar photovoltaic array system in a second intermediate configuration between stowed and deployed in accordance with the present invention.

FIGS. 5A-5D are a top plan view, a front perspective view, a side elevation view, and a front elevation view of the balanced deployable solar photovoltaic array system in a fully deployed configuration in accordance with the present invention.

FIG. 6 is a side elevation view of the balanced deployable solar photovoltaic array system in a stowed configuration in accordance with the present invention.

FIG. 7 is a side elevation view of the balanced deployable solar photovoltaic array system in the first intermediate configuration between stowed and deployed in accordance with the present invention.

FIG. 8 is a side elevation view of the balanced deployable solar photovoltaic array system in the second intermediate configuration between stowed and deployed in accordance with the present invention.

FIG. 9 is a side elevation view of the balanced deployable solar photovoltaic array system in a deployed configuration in accordance with the present invention.

### DETAILED DESCRIPTION OF THE PREFERRED EMBODIMENT

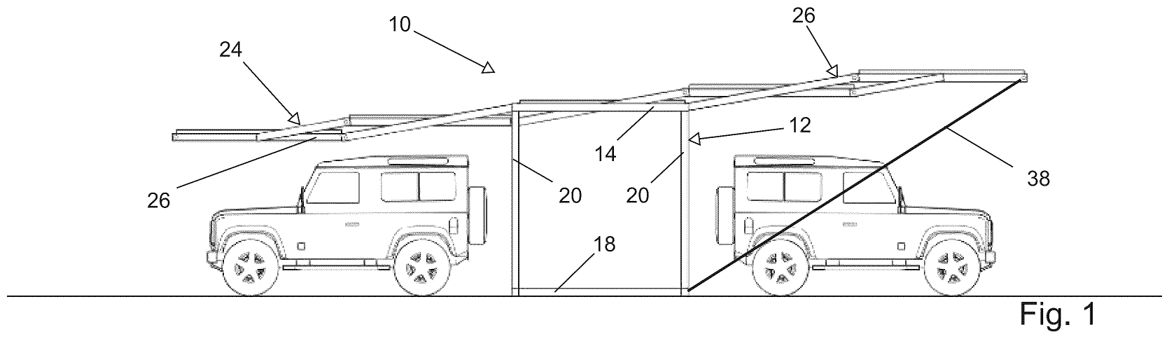

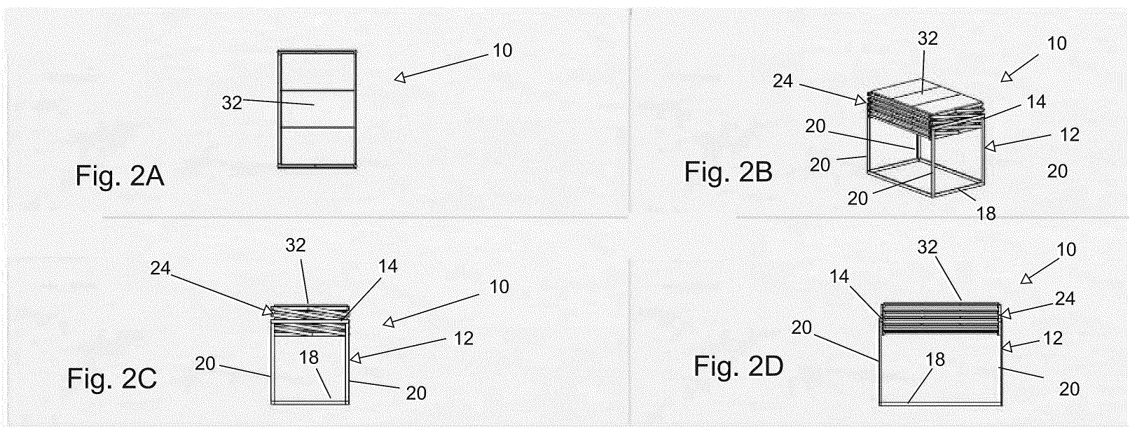

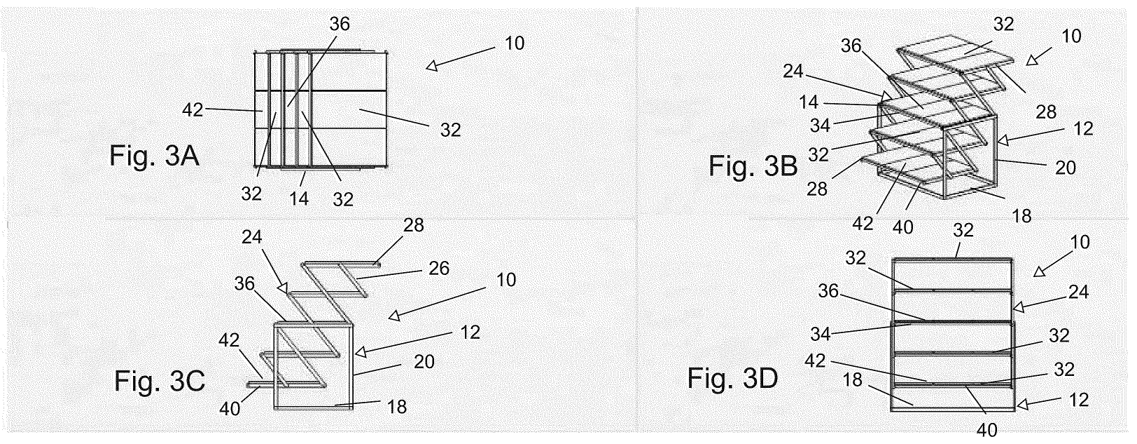

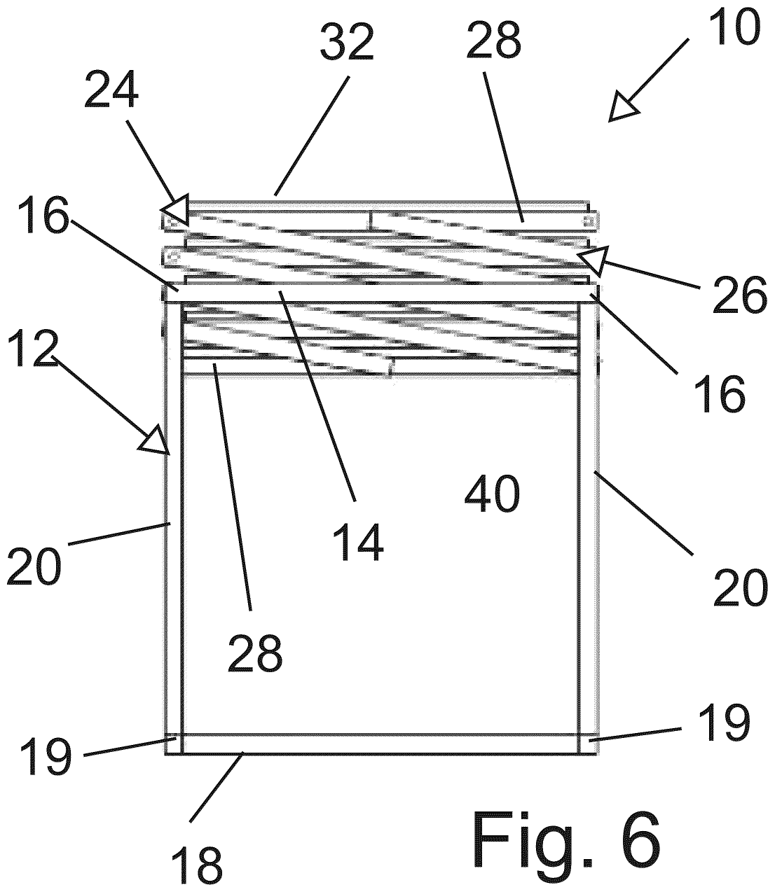

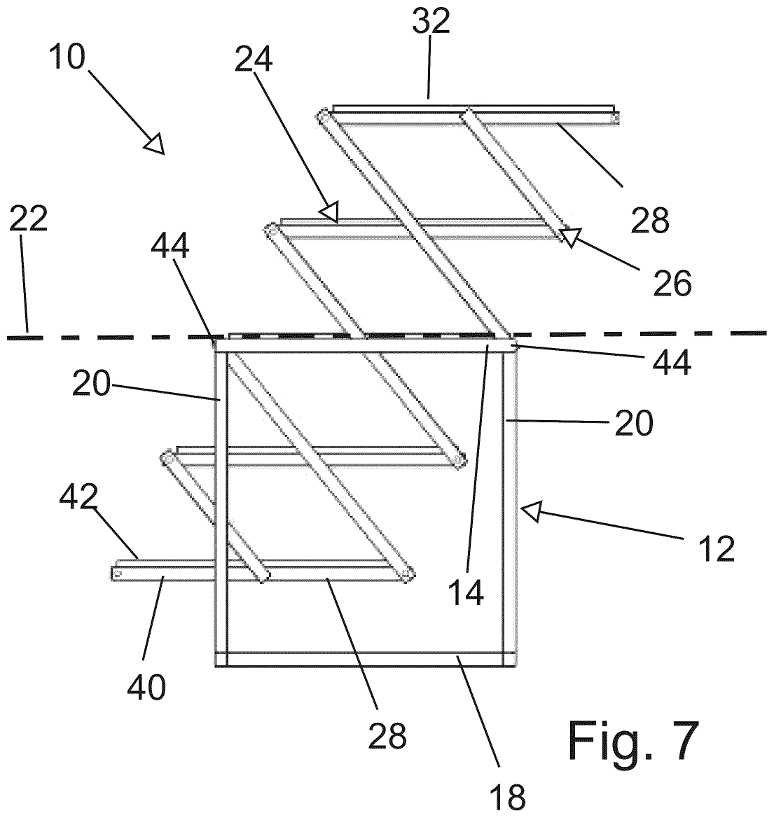

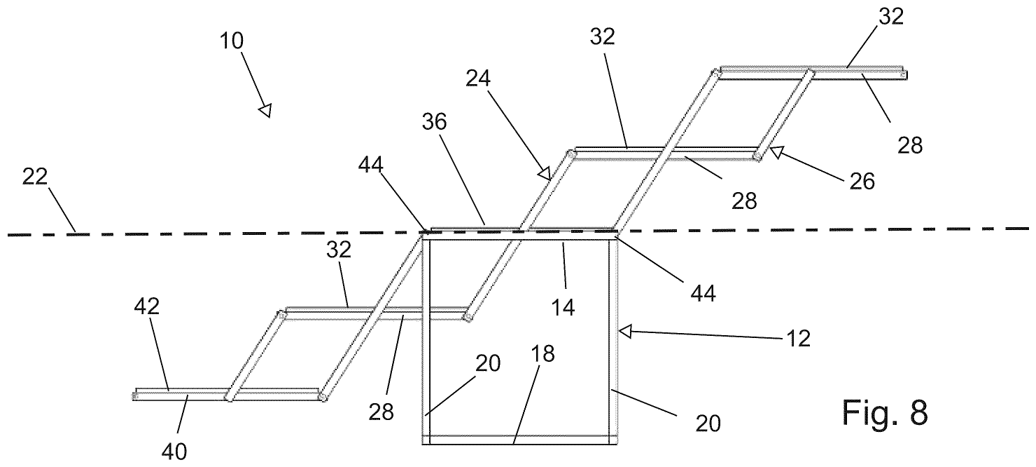

With reference to FIGS. 1-9, a balanced solar array system 10 of the present invention comprises a base 12 that supports a foldable solar panel array 24. The base 12 has a hexahedron shape that may be either a cube shape or rectangular cuboid shape. The base 12 has an upper frame 14 and a lower frame 18. The upper frame 14 and the lower frame 18 have quadrilateral shapes, either square or rectangular. The upper frame 14 is the same size as the lower frame 18. With reference to FIG. 6, the upper frame 14 and lower frame 18 are connected at their four corners 16 and 19 by vertical corner posts 20.

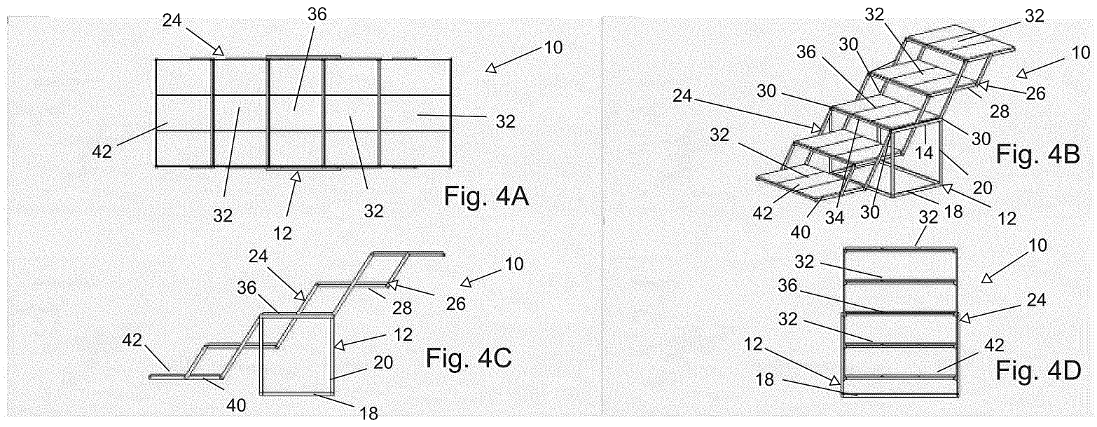

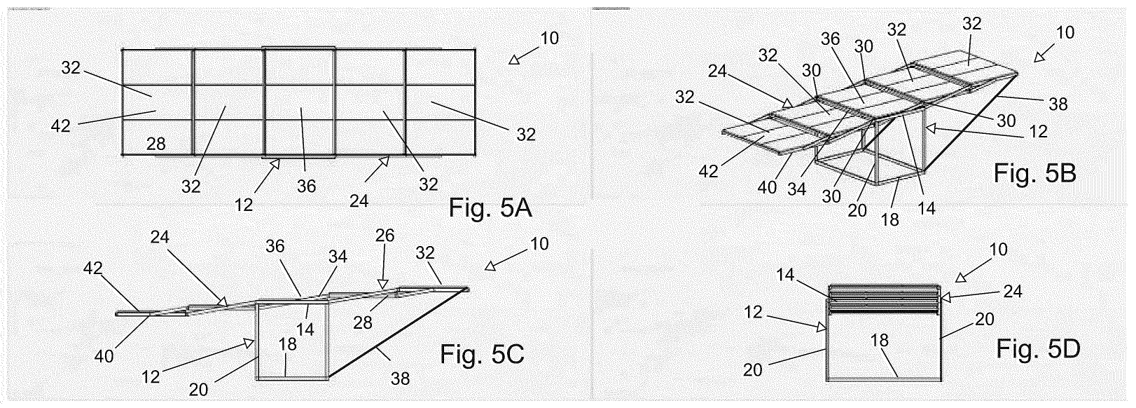

The foldable solar panel array 24 comprises a four-point expandable scissor structure 26 with a number of support sections 28. Each support section 28 supports a solar photovoltaic panel or panels 32. A center support section 34 of the expandable scissor structure 26, with its center photovoltaic panel 36, is fixed to the upper frame 14 of the base 12. As shown in FIGS. 4B and 5B, the four corners 30 of the center support section 34 of the expandable scissor structure 26 are connected to the four corners 16 of the upper frame 14 (FIG. 6). A zero line 22 lies in the plane of upper frame 14 and extends in the direction of the length of the foldable solar panel array 24 when unfolded and deployed.

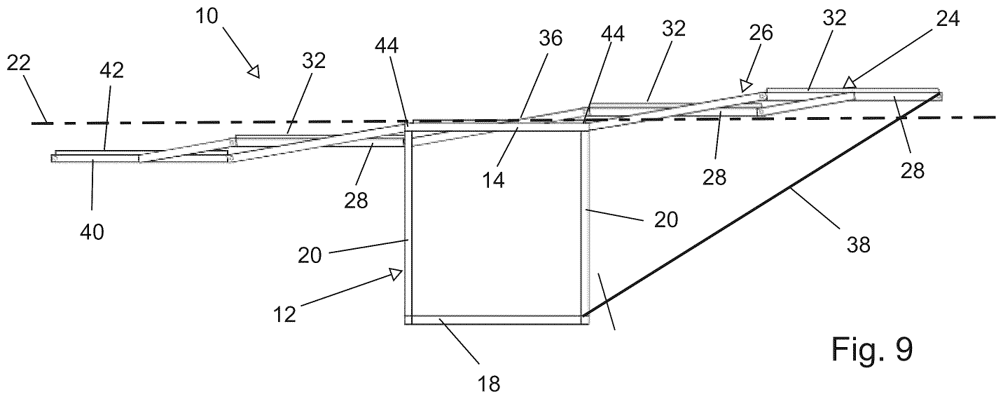

The sequential steps in deploying the foldable solar panel array 24 are shown sequentially in FIGS. 6-9. In order to deploy the stowed foldable solar panel array 24 starting with FIG. 6 and moving sequentially through FIG. 9, the lowermost support section 40, with its lowermost solar photovoltaic panel 42, is pulled downwardly and rearwardly, which causes the upper support sections 28 above the center support section 34 to move upwardly and forwardly. Because the center support section 34 of the foldable solar panel array 24 is fixed to the stationary upper frame 14, the lower support sections 28 of the expandable scissor structure 26 move downwardly, rearwardly, and then upwardly while the upper support sections 28 above the center support section 34 move upwardly, forwardly, and downwardly until the expandable scissor structure 26 lies essentially parallel to the zero line 22. In that position, the balanced solar array system 10 is in a fully deployed configuration as shown in FIGS. 1 and 9.

Once the balanced solar array system is in the deployed configuration shown in FIGS. 1 and 9, a tiedown strap or straps 38 is connected to a forward end of the uppermost support section 28 and to the forward and of the lower frame 18. The tiedown strap 38 holds the foldable solar panel array 24 in its deployed configuration.

The foldable solar panel array 24 is stowed in the sequential steps beginning with FIG. 9 and progressing to FIG. 6. The foldable solar panel array 24 is stowed by first removing the tiedown strap or straps 38, pulling downwardly, forwardly, and then upwardly on the lowermost support section 40, which in turn causes the uppermost support sections 28 above the center support section 34 to move upwardly, rearwardly, and then downwardly to the stowed configuration shown in FIG. 6.

The support sections 28 extending in the first direction from the center support section 34 and the support sections 28 extending in the second direction from the center support 34 are configured so that the foldable solar panel array 24 balances about the center support section 34.

While this invention has been described with reference to preferred embodiments thereof, it is to be understood that variations and modifications can be affected within the spirit and scope of the invention as described herein and as described in the appended claims.

I claim:

1. A balanced solar array system comprising:
a. a base with an elevated upper frame; and
b. a foldable solar panel array comprising a four-point expandable scissor structure with a plurality of support sections that support photovoltaic panels,
wherein a center support section of the expandable scissor structure is attached to the upper frame and support sections adjacent the center support section are rotatably connected to the center support section.

2. The balanced solar array system of claim 1, wherein the expandable scissor structure includes one or more lower support sections displaced in a first direction from the center support section and one or more upper support sections displaced in a second direction from the center support section such that the lower support sections with photovoltaic panels and the upper support sections with photovoltaic panels are balanced as the lower support sections and the upper support sections rotate from the intermediate support section.

3. The balanced solar array system stem of claim 1, wherein the balanced deployable solar photoelectric array system further includes a tiedown strap installed between the one of the upper support sections and the base when the foldable solar panel array is in a deployed configuration.

4. A method for deploying a balanced solar array system comprising the steps of:
a. providing a base with an elevated upper frame;
b. providing a four-point expandable scissor structure with a plurality of support sections that support solar photovoltaic panels, wherein the expandable scissor structure has a center support section, lower support sections displaced from the center support section in a first direction, and upper support sections displaced from the center support section in a second direction;
c. attaching the center support section of the expandable scissor structure to the upper frame, wherein the lower support sections are stacked below the center support section and the upper support sections are stacked above the center support section;
d. deploying the expandable scissor support by moving a lowermost support section downwardly, rearwardly, and then upwardly wherein at the same time the uppermost support sections move upwardly, forwardly, and then downwardly until the expandable scissor structure is generally aligned with a plane defined by the upper frame.

5. The method of claim 4, wherein upon deployment of the balanced solar array system, a tiedown strap is connected between the base and one of the upper support sections.

6. A method for stowing a balanced solar array system comprising the steps of:
a. providing a base with an elevated upper frame;
b. providing a four-point expandable scissor structure with a plurality of support sections that support solar photovoltaic panels, wherein the expandable scissor structure has a center support section attached to the upper frame, lower support sections displaced from the center support section in a first direction, and upper support sections displaced from the center support section in a second direction;
c. stowing the expandable scissor support by moving a lowermost support section downwardly, forwardly, and then upwardly so that at the same time the upper support sections move upwardly, rearwardly, and then downwardly until the expandable scissor structure is generally aligned with a plane defined by the upper frame.

7. The method of claim 6, wherein the method for stowing the balanced solar array system further includes first removing a tiedown strap connected between the base and one of the upper support sections.
